(19) United States
(12) Patent Application Publication
(10) Pub. No.: US 2005/0248610 A1
(43) Pub. Date: Nov. 10, 2005

(54) Caps and office machines utilizing the same

(75) Inventor: Ying-Hsien Kuo, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/122,914

(22) Filed: May 5, 2005

(30) Foreign Application Priority Data
May 5, 2004 (TW) 93112621

(51) Int. Cl. B41J 2/165

(52) U.S. Cl. 347/29

(57) ABSTRACT

A cap and an office machine utilizing the same. The office machine includes a body, a cartridge, and a capping device. The body includes a service area therein. The cartridge is moveably disposed on the body, and includes a chip and a housing. The capping device includes a cap, and is moveably disposed on the body. The cap comprises a first portion and a second portion. When the cartridge is located in the service area, the first portion abuts the housing, and the second portion abuts the chip.

### BACKGROUND

The invention relates to caps, and in particular, to caps for sealing cartridges of office machines.

A conventional capping device for office machines comprises a cap, a sled, and a housing. The cap covers the cartridge of the office machine to prevent ink remaining at an exit of the cartridge from drying, thus preventing a nozzle of the cartridge from clogging. The sled moves the cap. The housing supports the sled. When a carrier supporting the cartridge moves leftward/rightward along rails of the office machine, the cap is moved downward/upward.

FIGS. 1a and 1b depict a conventional capping device 10. When the carrier moves leftward/rightward, it drives a sled 11 of the capping device 10 to move a cap 12 upward to cover the cartridge. When the cartridge is covered by the cap 12, it enters a closed state from an open state.

The cap may comprise a through hole to prevent upward pressure from exceeding a critical value when covering the cartridge. Since external air may flow into the cartridge through the through hole of the cap, ink in the cartridge may dry after a long period even if the cap covers the cartridge.

Additionally, since the movement of the cap is driven by the carrier, a periphery 12a of the cap 12 may be lifted to be deformed during moving. Thus, a gap may be generated between the cap and the cartridge so that ink in the cartridge may dry after a long period.

FIGS. 2a-2d depict another conventional capping device as disclosed in U.S. Pat. No. 5,956,053. A cap 20 comprises a through hole 21 so that the cartridge remains in an open state even if the cap 20 covers the cartridge. Furthermore, FIGS. 2c-2d depict a cross section of the cap 20 when covering the cartridge, wherein the cap 20 has a central portion deflected downward into a hollow deflection cavity to form a smiling shape. Two extreme edges of this smile-shaped deflection form a dual seal, and may receive foreign matter therebetween.

Moreover, as shown in FIG. 2a, a vent passageway for the through hole 21 is spiral to slow airflow into the cartridge via the cap. Nevertheless, the spiral vent passageway may be difficult to mass-produce. Also, since the cartridge remains in the open state even if the cap 20 covers thereon, external air may flow into the cartridge, thus affecting quality of ink in the cartridge.

### SUMMARY

An office machine is provided. An exemplary embodiment of an office machine comprises a body, a cartridge, and a capping device. The body comprises a service area. The cartridge comprises a chip and a housing, and is moveably disposed on the body. The capping device comprises a cap, and is moveably disposed on the body. The cap comprises a first portion, a second portion, and a space between the first portion and the second portion. When the cartridge is located in the service area, the first portion abuts the housing, and the second portion abuts the chip.

Furthermore, the first portion surrounds the second portion. The second portion abuts the chip in a surface contact manner. The cap comprises a third portion connecting the first portion and the second portion. A cross section of the second portion is trapezoid.

Additionally, the office machine may be an inkjet-type copy machine, an inkjet-type fax machine, or an inkjet-type printer.

A cap for an office machine is also provided. The office machine comprises a cartridge with a chip and a housing. An exemplary embodiment of a cap comprises a first portion and a second portion. The first portion separably abuts the housing. The second portion is integrally formed with the first portion. A space is formed between the first portion and the second portion. The second portion separably abuts the chip.

### DESCRIPTION OF THE DRAWINGS

The invention can be more fully understood by reading the subsequent detailed description and examples with references made to the accompanying drawings, wherein:

FIGS. 1a and 1b are schematic views of a conventional capping device;

FIGS. 2a-2d are schematic views of another conventional capping device as disclosed in U.S. Pat. No. 5,956,053;

FIGS. 3a and 3b are schematic views of an embodiment of an office machine;

FIG. 3c is a schematic view of a cartridge and a cap in FIG. 3b;

FIG. 3d is an enlarged view of a portion D in FIG. 3c;

FIG. 3e depicts another embodiment of a cap; and

FIG. 4 is another schematic view of the cap in FIG. 3b.

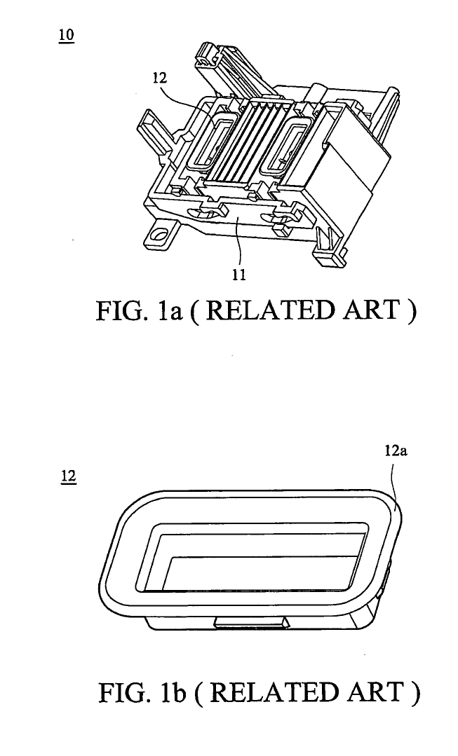

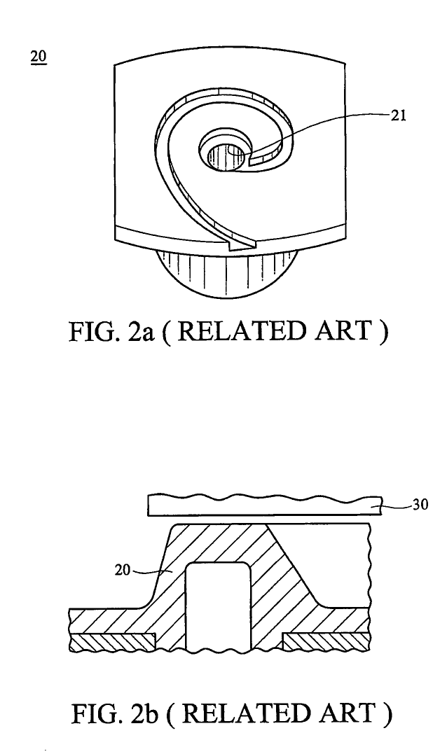

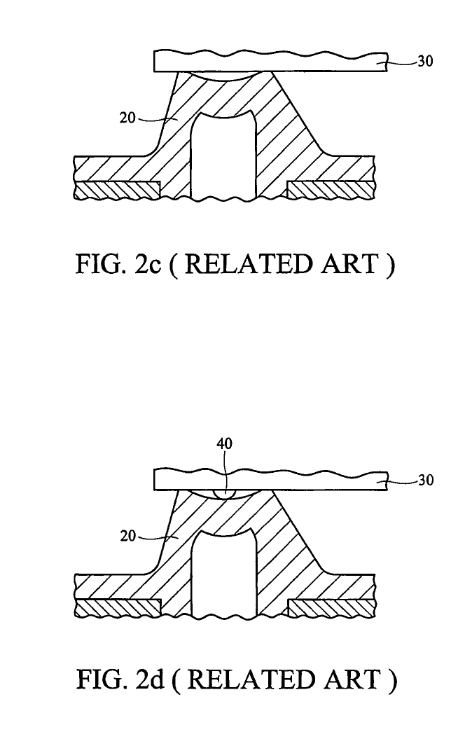

### DETAILED DESCRIPTION

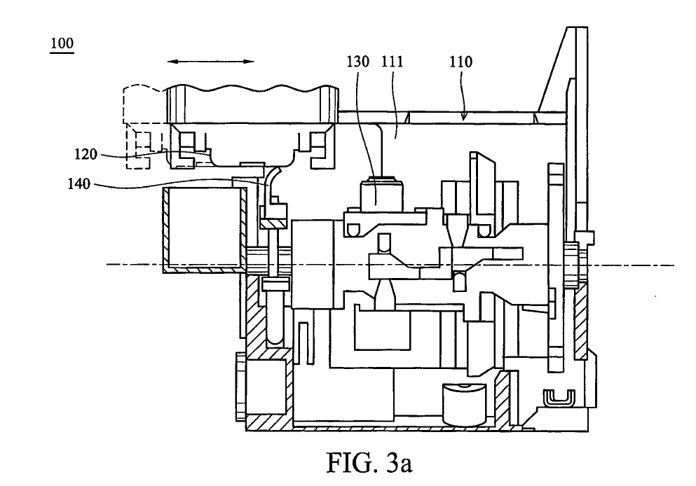

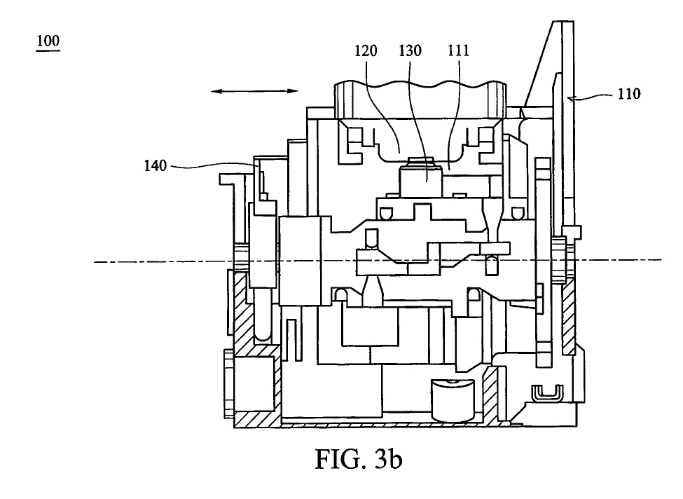

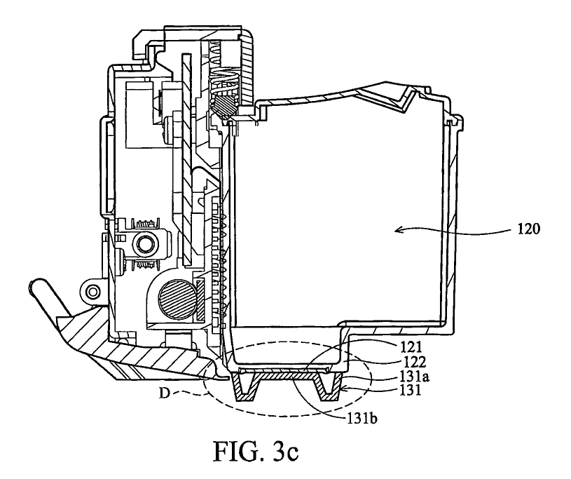

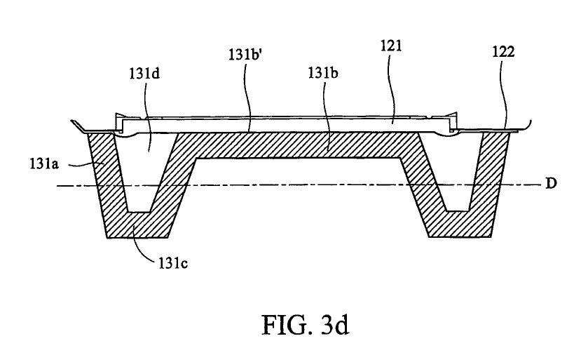

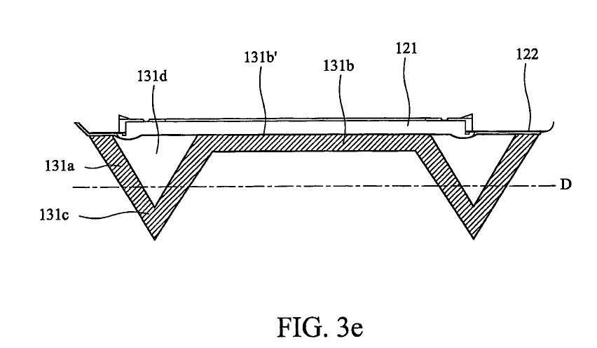

FIGS. 3a and 3b depict an embodiment of an office machine 100. The office machine 100 comprises a body 110, a cartridge 120, a capping device 130, and a wiper 140.

The body 110 is a basic component of the office machine 100, and comprises a service area 111 in which the capping device 130 and the wiper 140 are disposed. When the cartridge 120 returns to the service area 111, it is covered by the capping device 130 after ink remaining on the cartridge 120 is wiped by the wiper 140.

As shown in FIGS. 3a-3c, the cartridge 120 comprises a chip 121 and a housing 122, and is disposed on the body 110 to move leftward/rightward. The capping device 130 comprises a cap 131, and is disposed on the body 110 to move upward/downward, as shown in FIGS. 3a and 3b.

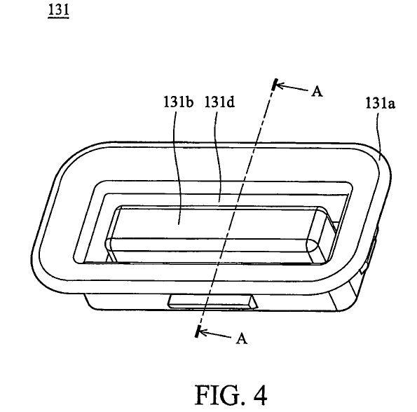

Referring to FIG. 4, the cap 131 comprises a first portion 131a, a second portion 131b, and a third portion 131c. The first, second, and third portions 131, 132, and 133 are divided by a line D-D in FIG. 3d. The first portion 131a surrounds the second portion 131b. FIG. 3d is a cross section along a line A-A in FIG. 4. As shown in FIG. 3d, a cross section of the second portion 131b is substantially trapezoid. A space 131d is formed between the first portion 131a and the second portion 131b. The third portion 131c connects the first portion 131a and the second portion 131b.

Additionally, while the third portion 131c is flat in FIG. 3d, it is not limited thereto, and may be sharp as shown in FIG. 3e.

Thus, when the cartridge 120 is located in the service area 111 of the body 110 to be sealed by the capping device 130, the first and second portions 131a and 131b of the cap 131 first contact the cartridge 120. After the cap 131 is lifted to a predetermined position, the first portion 131a abuts the housing 122 of the cartridge 120 and spreads out, and a surface 131b′ of the second portion 131b abuts the chip 121 of the cartridge 120 in a surface contact manner to form a dual seal. As a result, ink in the cartridge resists drying after a long period.

The office machine may be an inkjet-type copy machine, an inkjet-type fax machine, or an inkjet-type printer.

As previously described, the cartridge can be stably sealed by the cap of this embodiment. Specifically, even if the first portion of the cap is lifted due to the movement of the carrier of the cartridge, the cartridge may still be sealed by the second portion of the cap.

Additionally, note that different kinds of ink in the cartridge may be mixed when the second portion of the cap abuts the chip of the cartridge. Nevertheless, the cartridge can be wiped again by the wiper before dispensing, thus solving ink-mixture problem.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An office machine comprising:
a body comprising a service area;
a cartridge, comprising a chip and a housing, moveably disposed on the body; and
a capping device, comprising a cap, moveably disposed on the body, wherein the cap comprises a first portion, a second portion, and a space between the first portion and the second portion;
wherein when the cartridge is located in the service area, the first portion abuts the housing, and the second portion abuts the chip.

2. The office machine as claimed in claim 1, wherein the first portion surrounds the second portion.

3. The office machine as claimed in claim 1, wherein the second portion abuts the chip in a surface contact manner.

4. The office machine as claimed in claim 1, wherein the cap further comprises a third portion connecting the first portion and the second portion.

5. The office machine as claimed in claim 1, wherein a cross section of the second portion is trapezoid.

6. The office machine as claimed in claim 1, wherein the office machine is an inkjet-type copy machine.

7. The office machine as claimed in claim 1, wherein the office machine is an inkjet-type fax machine.

8. The office machine as claimed in claim 1, wherein the office machine is an inkjet-type printer.

9. A cap for an office machine with a cartridge, wherein the cartridge comprises a chip and a housing, and the cap comprises:
a first portion separably abutting the housing; and
a second portion integrally formed with the first portion, wherein a space is formed between the first portion and the second portion, and the second portion separably abuts the chip.

10. The cap as claimed in claim 9, wherein the first portion surrounds the second portion.

11. The cap as claimed in claim 9, wherein the second portion abuts the chip in a surface contact manner.

12. The cap as claimed in claim 9, further comprising a third portion connecting the first portion and the second portion.

13. The cap as claimed in claim 9, wherein a cross section of the second portion is trapezoid.
